(19) United States
(12) Patent Application Publication
(10) Pub. No.: US 2011/0200753 A1
(43) Pub. Date: Aug. 18, 2011

(54) APPARATUS AND METHOD FOR MANUFACTURING SUBSTRATE

(76) Inventors: Dong Joo Shin, Gyunggi-do (KR); Choon Keun Lee, Gyunggi-do (KR); Sung Taek Lim, Gyunggi-do (KR)

(21) Appl. No.: 12/762,924

(22) Filed: Apr. 19, 2010

(30) Foreign Application Priority Data
Feb. 12, 2010 (KR) 10-2010-0013576

(51) Int. Cl. B05D 3/12; B05C 11/00

(52) U.S. Cl. 427/299; 118/50; 118/72

(57) ABSTRACT

Disclosed herein is an apparatus for manufacturing a substrate, including: a first chamber supplying an insulation layer; a second chamber including a roughening roller roughening at least one side of the insulation layer supplied from the first chamber, an evaporator depositing a metal layer on the roughened insulation layer, and a pressing roller pressing the insulation layer and the metal layer; and a third chamber storing the insulation layer including the metal layer formed thereon, the insulation layer being taken out from the second chamber. The apparatus for manufacturing a substrate is advantageous in that substrates are continuously produced, thus increasing the productivity of the substrates and preventing the substrates from being contaminated by the air.

### CROSS REFERENCE TO RELATED APPLICATION

This application claims the benefit of Korean Patent Application No. 10-2010-0013576, filed Feb. 12, 2010, entitled “Apparatus and method for manufacturing substrate”, which is hereby incorporated by reference in its entirety into this application.

### BACKGROUND OF THE INVENTION

1. Technical Field

The present invention relates to an apparatus and method for manufacturing a substrate.

2. Description of the Related Art

Recently, in order to keep up with the densification of semiconductor chips and the increase of signal transfer speed, a technology of directly mounting a semiconductor chip in a substrate has been increasingly required. Therefore, it is also required to develop a high-density and high-reliability substrate which can cope with the densification of semiconductor chips.

The required specifications of a high-density and high-reliability substrate are closely related to the specifications of a semiconductor chip, and have many problems to be solved, such as miniaturization of circuits, excellent electrical properties, high-speed signal transmission, high reliability, high functionality and the like. In response to such specifications, a technology of forming micro circuit patterns and micro viaholes in a substrate is required, and thus research into this technology is being variously made. Further, in order to increase the productivity in manufacturing a substrate, methods of automatically manufacturing a substrate are being researched.

FIG. 1 is a view showing a conventional apparatus and method for manufacturing a substrate. Hereinafter, the conventional apparatus and method for manufacturing a substrate will be described with reference to FIG. 1 as follows.

First, an insulation layer 11 and copper foil 12 are supplied to a substrate manufacturing apparatus 10, and then the copper foil 12 is disposed on both sides of the insulation layer 11.

Subsequently, the copper foil 12 is attached onto both sides of the insulation layer 11 by the substrate manufacturing apparatus 10. Concretely, the substrate manufacturing apparatus 10 comprises a pair of hot plates 14 and a pair of press plates 15, and the copper foil 12 is thermally attached to the insulation layer 11 under vacuum by pressing the copper foil 12 using the press plates 15 and then heating the pressed copper foil 12 using the hot plates 14.

Subsequently, the insulation layer 11 coated with the copper foil 12 is cooled and then separated from the press plates 15 and the hot plates 14 to manufacture a substrate 13.

However, the conventional apparatus and method for manufacturing a substrate is problematic in that both the supply of the insulation layer 11 and the copper foil 12 and the detachment of the substrate are performed by manual work, thus increasing defective fraction and decreasing productivity.

Further, the conventional apparatus and method for manufacturing a substrate is problematic in that a process of manufacturing the substrate 13 is performed in a state in which the substrate 13 is exposed to the outside, and thus the insulation layer 11 is oxidized by the air or contaminated by dust etc.

### SUMMARY OF THE INVENTION

Accordingly, the present invention has been made to solve the above-mentioned problems, and the present invention provides an apparatus and method for manufacturing a substrate, which can decrease defective fraction and increase productivity by automatically and continuously manufacturing a substrate.

Further, the present invention provides an apparatus and method for manufacturing a substrate, which can prevent the contamination of a substrate by blocking the air during a process of manufacturing the substrate.

An aspect of the present invention provides an apparatus for manufacturing a substrate, including: a first chamber supplying an insulation layer; a second chamber including a roughening roller roughening at least one side of the insulation layer supplied from the first chamber, an evaporator depositing a metal layer on the roughened insulation layer, and a pressing roller pressing the insulation layer and the metal layer; and a third chamber storing the insulation layer including the metal layer formed thereon, the insulation layer being taken out from the second chamber.

Here, the first chamber, the second chamber and the third chamber may be maintained at a vacuum state, and the first chamber and the third chamber may allow the vacuum state to be released.

Further, the second chamber may further include a first heater disposed in front of the roughening roller and heating the insulation layer, and a first cooler disposed behind the roughening roller and cooling the insulation layer.

Further, the first heater and the first cooler may have a roll shape, and thus the insulation layer may be continuously transferred.

Further, the second chamber may further include a second heater disposed in front of the pressing roller and heating the insulation layer, and a second cooler disposed behind the pressing roller and cooling the insulation layer.

Further, the second heater and the second cooler may have a roll shape, and thus the insulation layer including the metal layer formed thereon may be continuously transferred.

Further, the evaporator may be an e-beam evaporator.

Further, the insulation layer may be made of prepreg, and the metal layer may be made of copper.

Further, the apparatus for manufacturing a substrate may further include a conveyor continuously transferring the insulation layer in order of the first chamber, the roughening roller, the evaporator, the pressing roller and the third chamber.

Another aspect of the present invention provides a method of manufacturing a substrate, including: supplying an insulation layer from a first chamber to a second chamber; roughening at least one side of the insulation layer supplied to the second chamber; depositing a metal layer on the roughened insulation layer; pressing the insulation layer deposited with the metal layer; and transferring the pressed insulation layer including the metal layer formed thereon to a third chamber.

Here, the first chamber, the second chamber and the third chamber may be maintained at a vacuum state.

Further, the roughening of the at least one side of the insulation layer may include: heating the insulation layer supplied to the second chamber; roughening the heated insulation layer; and cooling the roughened insulation layer.

Further, the pressing of the insulation layer deposited with the metal layer may include: heating the insulation layer deposited with the metal layer; pressing the heated insulation layer and metal layer; and cooling the pressed insulation layer and metal layer.

Further, in the depositing of the metal layer, the metal layer may be deposited on the insulation layer using an e-beam evaporator.

Further, the insulation layer may be made of prepreg, and the metal layer may be made of copper.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional apparatus and method for manufacturing a substrate;

FIG. 2 is a sectional view showing an apparatus for manufacturing a substrate according to an embodiment of the present invention; and

FIG. 3 is a flowchart showing a method of manufacturing a substrate according to an embodiment of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “first,” “second” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

Apparatus for Manufacturing Substrate

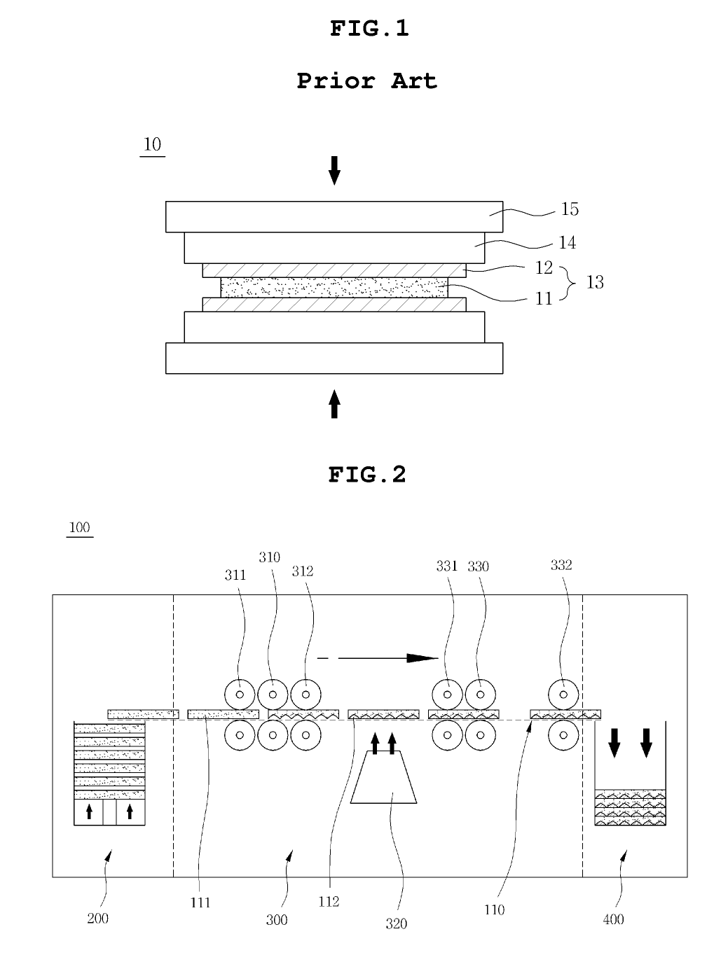

FIG. 2 is a sectional view showing an apparatus for manufacturing a substrate according to an embodiment of the present invention. Hereinafter, the apparatus for manufacturing a substrate according to this embodiment will be described with reference to FIG. 2.

As shown in FIG. 2, the apparatus 100 for manufacturing a substrate according to this embodiment includes a first chamber 200; a second chamber 300 including a roughening roller 310, an evaporator 320 and a pressing roller 330; and a third chamber 400.

The first chamber 200 serves to supply insulation layers 111 to the second chamber 300.

Here, since the first chamber 200 can be maintained at vacuum, it is possible to prevent the insulation layers 111 from being oxidized by the air or contaminated by dust, etc. Meanwhile, when all of the insulation layers 111 in the first chamber 200 are supplied to the second chamber 200, the vacuum state of the first chamber 200 is released, and then the first chamber 200 may be replenished with insulation layers 111.

The second chamber 300 serves to form a metal layer 112 on the insulation layer 111 supplied from the first chamber 200 and to send a substrate 110 to the third chamber 400, and includes a roughening roller 310, an evaporator 320 and a pressing roller 330.

Meanwhile, the second chamber 300, similarly to the first chamber 200, is maintained at vacuum, thus preventing foreign matter from being introduced into the second chamber 300.

The roughening roller 310 serves to roughen the insulation layer 111 transferred from the first chamber 200.

Here, the roughening roller 310 can roughen the insulation layer 111 in the form of an intaglio or a relievo because its surface is uneven. In this case, since the roughening roller 310 allows the insulation layer 111 to be roughened, the adhesion between the insulation layer 112 and a metal layer may be stronger. Further, since the roughening roller 12 has a roll shape, the insulation layers 111 can be continuously transferred to the evaporator 320.

Meanwhile, a first heater 311 and a first cooler 312 are disposed in front of and behind the roughening roller 310, respectively. The first heater 311 is disposed in front of the roughening roller 310, and serves to heat the insulation layer 111 to a semi-hardened state in order to easily roughen the insulation layer 111. The first cooler 312 is deposed behind the roughening roller 310, and serves to cool and harden the roughened insulation layer 111. Further, since the first heater 311 and the first cooler 312 also have a roll shape, the insulation layers 111 can be continuously transferred to the evaporator 320.

The evaporator 320 serves to form a metal layer 112 on the roughened insulation layer 111.

Here, an e-beam evaporator may be used as the evaporator 320. Concretely, a metal boat storing a metal is irradiated with electron beam to evaporate the metal, and then the evaporated metal is deposited on the surface of the insulation layer 111. In this case, when the insulation layer 111 is roughened, the adhesion between the insulation layer 111 and the metal layer 112 can be increased.

Meanwhile, since the metal layer 112 is formed by depositing the evaporated metal on the surface of the insulation layer 111, the thickness of the metal layer 112 can be reduced compared to when it is formed by pressing or plating, thus forming micro circuit patterns.

The pressing roller 330 serves to press the metal layer 112 and the insulation layer 111 deposited with the metal layer 112.

Here, since the pressing roller 330 includes two rollers, the insulation layer 111 and the metal layer 112 may be disposed between the two rollers and then pressed. Meanwhile, a second heater 331 and a second cooler 332 are disposed in front of and behind the pressing roller 330, respectively. The second heater 331 is disposed in front of the pressing roller 330, and serves to heat the insulation layer 111 deposited with the metal layer 112 to a semi-hardened state. The second cooler 332 is deposed behind the pressing roller 330, and serves to cool and harden the pressed insulation layer 111. In this case, the insulation layer 111 and the metal layer 112 can be easily pressed by the second heater 331 and the second cooler 332.

Further, since the second heater 331 and the second cooler 332, the same as the first heater 311 and the first cooler 312, also have a roll shape, the insulation layers 111 deposited with the metal layer 112 can be continuously transferred.

The third chamber 400 serves to store the substrate 110 transferred from the second chamber 300.

Here, the third chamber 400, the same as the first chamber, can be maintained at vacuum, and the vacuum state of the third chamber 400 can be released when the substrate 110 is taken out from the third chamber 400.

Meanwhile, the apparatus 100 for manufacturing a substrate may further include a conveyor (not shown) for transferring the insulation layer 111.

Here, the conveyor (not shown) can continuously transfer the insulation layer 111 in order of the first chamber 200, the roughening roller 310, the evaporator 320, the pressing roller 330 and the third chamber 400.

The substrate 110 is a product manufactured by the substrate manufacturing apparatus 100, and includes the insulation layer 111 and the metal layer 112.

Here, the insulation layer 111 may be made of a commonly-used epoxy resin, such as ABF (Ajinomoto Build up Film), FR-4, BT (Bismaleimide Triazine) or the like, preferably, prepreg. The metal layer 112 may be made of an electroconductive metal, preferably, copper.

Meanwhile, the substrate 110 may be a printed circuit board, preferably, a copper clad laminate (CCL) whose one side or both sides are coated with copper foil.

Meanwhile, it is shown in FIG. 2 that the metal layer 112 is formed on the only one side of the insulation layer 111, but the present invention is not limited thereto, and the metal layers 112 may be formed on both sides of the insulation layer 111. In this case, the roughening rollers 310, the evaporators 320 and the pressing rollers 330 may be disposed on both sides of the insulation layer 111.

Method of Manufacturing Substrate

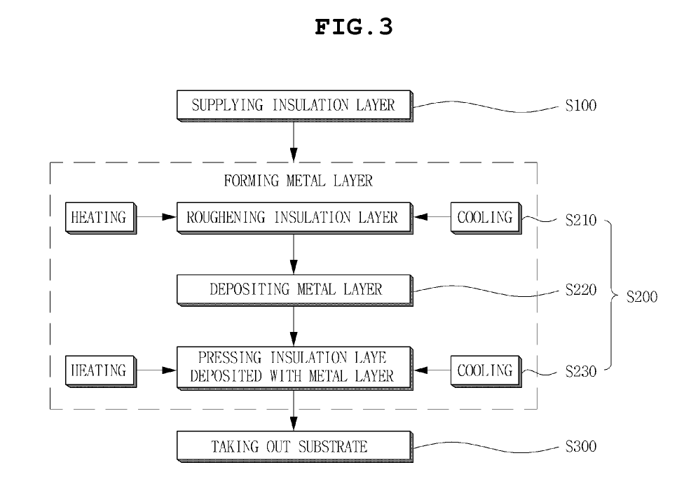

FIG. 3 is a flowchart showing a method of manufacturing a substrate according to an embodiment of the present invention. Hereinafter, the method of manufacturing a substrate according to this embodiment will be described with reference to FIG. 3.

As shown in FIG. 3, the method of manufacturing a substrate includes the steps of: supplying an insulation layer 111 (S100); forming a metal layer 112 (S200) including the steps of roughening the insulation layer 111 (S210), depositing a metal layer 112 on the insulation layer 111 (S220), and pressing the insulation layer 111 deposited with metal layer 112 (S230); and separating a substrate 110.

First, an insulation layer 111 is supplied into a second chamber 300 (S100).

In this case, the insulation layer 111 is taken out from a first chamber 200 and then transferred into the second chamber 300. Further, the first chamber 200 and the second chamber 300 are maintained at a vacuum state, and the vacuum state of the first chamber 200 may be released when the first chamber 200 is replenished with the insulation layer 111.

Subsequently, the insulation layer is roughened (S210).

In this case, the insulation layer 111 may be roughened using a roughening roller 310. Further, the insulation layer 111 may also be roughened by surface-treating the insulation layer using plasma. However, the method of roughening the insulation layer 111 is not limited thereto as long as the adhesion between the insulation layer 111 and a metal layer 112 is improved.

Meanwhile, before the insulation layer 111 is roughened, the insulation layer may be heated to a semi-hardened state in order to easily roughen the insulation layer 111, and, after the insulation layer is roughed, the roughened insulation layer 111 may be cooled to harden this insulation layer 111.

Subsequently, a metal layer 112 is deposited on the roughened insulation layer 111 (S220).

In this case, the metal layer 112 may be deposited on the surface of the roughened insulation layer 111 using an evaporator 320, for example, an e-beam evaporator.

Subsequently, the insulation layer 111 deposited with the metal layer 112 is pressed (S230).

In this case, the adhesion between the insulation layer 111 and the metal layer 112 can be further improved by pressing the insulation layer 111 and the metal layer 112. Further, before the insulation layer 111 deposited with the metal layer 112 is pressed, this insulation layer 111 may be heated in order to easily press it, and, after the insulation layer 111 deposited with the metal layer 112 is pressed, this pressed insulation layer 111 may be cooled in order to prevent the damage thereof.

Subsequently, the insulation layer 112 provided with the metal layer 112, that is, a substrate 110, is transferred to a third chamber 400 (S300).

In this case, the substrate 110 may be taken out from the second chamber 300 and then transferred to the third chamber 400. Further, the vacuum state of the third chamber 400, the same as the first chamber 200, may be released when the substrate 110 is taken out from the third chamber 400.

Through the above steps, the method of manufacturing a substrate according to an embodiment of the present invention is completed.

Meanwhile, a plating layer may be formed on the substrate 110 using the metal layer 112 as a seed layer.

As described above, according the apparatus and method for manufacturing a substrate of the present invention, substrates are continuously manufactured by a roughening roller, evaporator and pressing roller provided in a second chamber, thus increasing productivity and decreasing defective fraction.

Further, according to the present invention, first, second and third chambers are maintained at a vacuum state to prevent a substrate from being brought into contact with the air, thus preventing the substrate from being contaminated by the air.

Further, according to the present invention, the thickness and line width of a circuit pattern can be reduced because a thin metal layer can be formed by deposition.

Further, according to the present invention, the adhesion between an insulation layer and a metal layer becomes strong because a substrate is roughened by a roughening roller.

Further, according to the present invention, the adhesion between an insulation layer and a metal layer becomes stronger because the insulation layer and the metal layer are pressed by a pressing roller.

Further, according to the present invention, the roughening of an insulation layer and the pressing of the roughened insulation layer can be easily performed because heaters and coolers are provided in front of and behind a roughening roller and a pressing roller, respectively.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. An apparatus for manufacturing a substrate, comprising:
a first chamber supplying an insulation layer;
a second chamber including a roughening roller roughening at least one side of the insulation layer supplied from the first chamber, an evaporator depositing a metal layer on the roughened insulation layer, and a pressing roller pressing the insulation layer and the metal layer; and
a third chamber storing the insulation layer including the metal layer formed thereon, the insulation layer being taken out from the second chamber.

2. The apparatus for manufacturing a substrate according to claim 1, wherein the first chamber, the second chamber and the third chamber are maintained at a vacuum state, and the first chamber and the third chamber allow the vacuum state to be released.

3. The apparatus for manufacturing a substrate according to claim 1, wherein the second chamber further includes a first heater disposed in front of the roughening roller and heating the insulation layer, and a first cooler disposed behind the roughening roller and cooling the insulation layer.

4. The apparatus for manufacturing a substrate according to claim 3, wherein the first heater and the first cooler have a roll shape, and thus the insulation layer is continuously transferred.

5. The apparatus for manufacturing a substrate according to claim 1, wherein the second chamber further includes a second heater disposed in front of the pressing roller and heating the insulation layer, and a second cooler disposed behind the pressing roller and cooling the insulation layer.

6. The apparatus for manufacturing a substrate according to claim 5, wherein the second heater and the second cooler have a roll shape, and thus the insulation layer including the metal layer formed thereon is continuously transferred.

7. The apparatus for manufacturing a substrate according to claim 1, wherein the evaporator is an e-beam evaporator.

8. The apparatus for manufacturing a substrate according to claim 1, wherein the insulation layer is made of prepreg, and the metal layer is made of copper.

9. The apparatus for manufacturing a substrate according to claim 1, further comprising a conveyor continuously transferring the insulation layer in order of the first chamber, the roughening roller, the evaporator, the pressing roller and the third chamber.

10. A method of manufacturing a substrate, comprising:
supplying an insulation layer from a first chamber to a second chamber;
roughening at least one side of the insulation layer supplied to the second chamber;
depositing a metal layer on the roughened insulation layer;
pressing the insulation layer deposited with the metal layer; and
transferring the pressed insulation layer including the metal layer formed thereon to a third chamber.

11. The method of manufacturing a substrate according to claim 10, wherein the first chamber, the second chamber and the third chamber are maintained at a vacuum state.

12. The method of manufacturing a substrate according to claim 10, wherein the roughening of the at least one side of the insulation layer comprises:
heating the insulation layer supplied to the second chamber;
roughening the heated insulation layer; and
cooling the roughened insulation layer.

13. The method of manufacturing a substrate according to claim 10, wherein the pressing of the insulation layer deposited with the metal layer comprises:
heating the insulation layer deposited with the metal layer;
pressing the heated insulation layer and metal layer; and
cooling the pressed insulation layer and metal layer.

14. The method of manufacturing a substrate according to claim 10, wherein, in the depositing of the metal layer, the metal layer is deposited on the insulation layer using an e-beam evaporator.

15. The method of manufacturing a substrate according to claim 10, wherein the insulation layer is made of prepreg, and the metal layer is made of copper.
